(19) United States
(12) Patent Application Publication
(10) Pub. No.: US 2009/0271253 A1
(43) Pub. Date: Oct. 29, 2009

(54) Electronic issuing of gift cards

(76) Inventors: Haim E. Arazy, Saddle Brook, NJ (US); Simeon H. Lifschitz, Englewood, NJ (US)

Correspondence Address: DILLON & YUDELL LLP, 8911 N. CAPITAL OF TEXAS HWY.,, SUITE 2110, AUSTIN, TX, 78759, US

(21) Appl. No.: 12/108,238

(22) Filed: Apr. 23, 2008

(51) Int. Cl. G06Q 30/00

(52) U.S. Cl. 705/14

(57) ABSTRACT

A method of issuing and managing an electronic gift card is presented. A gift card purchase order for a primary electronic gift card is received by a gift card issuing server. The gift card issuing server transmits a unique gift card identifier to the purchaser of the primary electronic gift card. The purchaser then has the option of partitioning the gift card into multiple split gift cards, which are sent, via e-mail or text messages, to split gift card assignees.

### BACKGROUND OF THE INVENTION

1. Technical Field

The present disclosure relates in general to the field of gift cards, and particularly to electronic gift cards. Still more particularly, the present disclosure relates to issuing and managing electronic gift cards in a secure manner.

2. Description of the Related Art

Rather than giving physical gifts or money, many people choose to give gift cards, which allow the recipient the option of selecting a particular gift from a participating store. Since such gift cards are physical cards, they are subject to theft and/or fraudulent use. Furthermore, since such gift cards are for a fixed denomination (value), they often expire with unused amounts of value.

### SUMMARY OF THE INVENTION

A method of issuing and managing an electronic gift card is presented. A gift card purchase order for a primary electronic gift card is received by a gift card issuing server. The gift card issuing server transmits a first unique gift card identifier to the purchaser of the primary electronic gift card. The purchaser then has the option of partitioning the gift card into multiple gift cards, which are sent, via e-mail or text messages, to split gift card assignees.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary computer in which the present invention may be utilized;

FIG. 2 depicts a high-level flow-chart describing exemplary steps for issuing and managing electronic gift cards in accordance with the present invention;

FIGS. 3A-B are flow-charts showing steps taken to deploy software capable of executing the steps and processes described in FIG. 2; and

FIGS. 4A-B are flow-charts showing steps taken to execute the steps and processes shown in FIG. 2 using an on-demand service provider;

### DETAILED DESCRIPTION OF THE PREFERRED EMBODIMENT

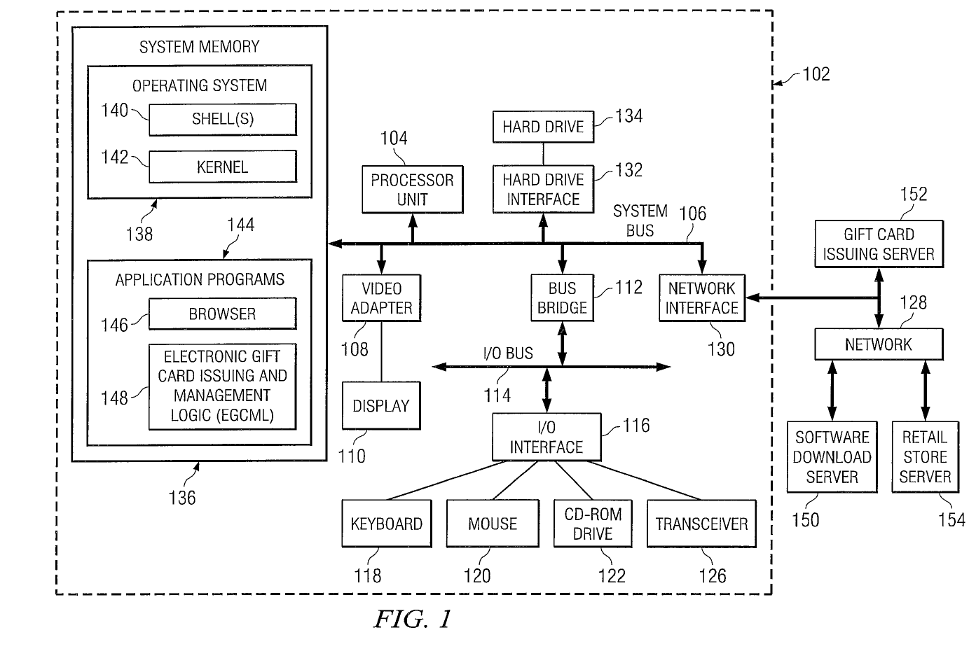

With reference flow to FIG. 1, there is depicted a block diagram of an exemplary computer 102, in which the present invention may be utilized. Note that some or all of the exemplary architecture shown for computer 102 may be utilized by software deploying server 150, gift card issuing server 152, and/or retail store server 154. Note further that, with the use of a transceiver 126 shown in FIG. 1, computer 102 describes requisite hardware for a telephone, including a cellular phone, and more specifically, a “smart phone” such as a Personal Digital Assistant (PDA) phone, etc., which may be utilized in the present invention.

Computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a transceiver 126. Transceiver 126 may be a wire-based or wireless-based transceiver, capable of transmitting and receiving a signal using a wired or a wireless medium (e.g., a radio wave). The format of the ports connected to I/O interface 116 may be any known to those skilled in the art of computer architecture, including but not limited to Universal Serial Bus (USB) ports.

Computer 102 is able to communicate with a software deploying server 150, a gift card issuing server 152, and/or a retail store server 154 via a network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (also called a command processor) is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150.

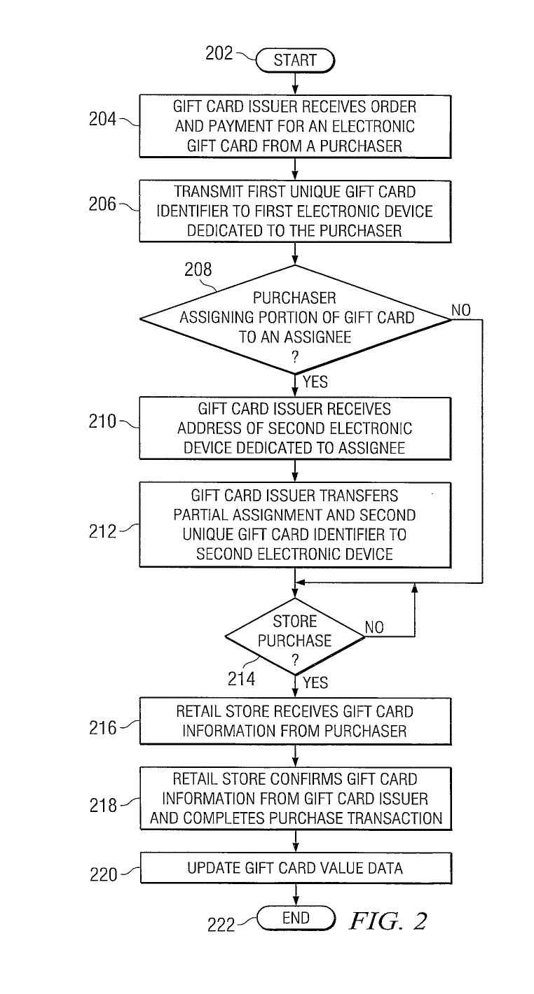

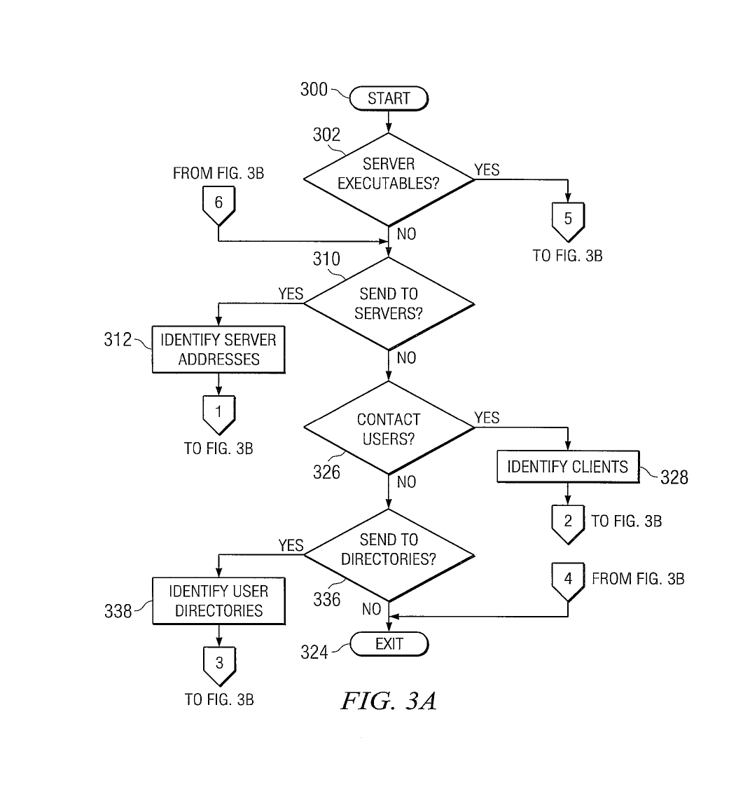

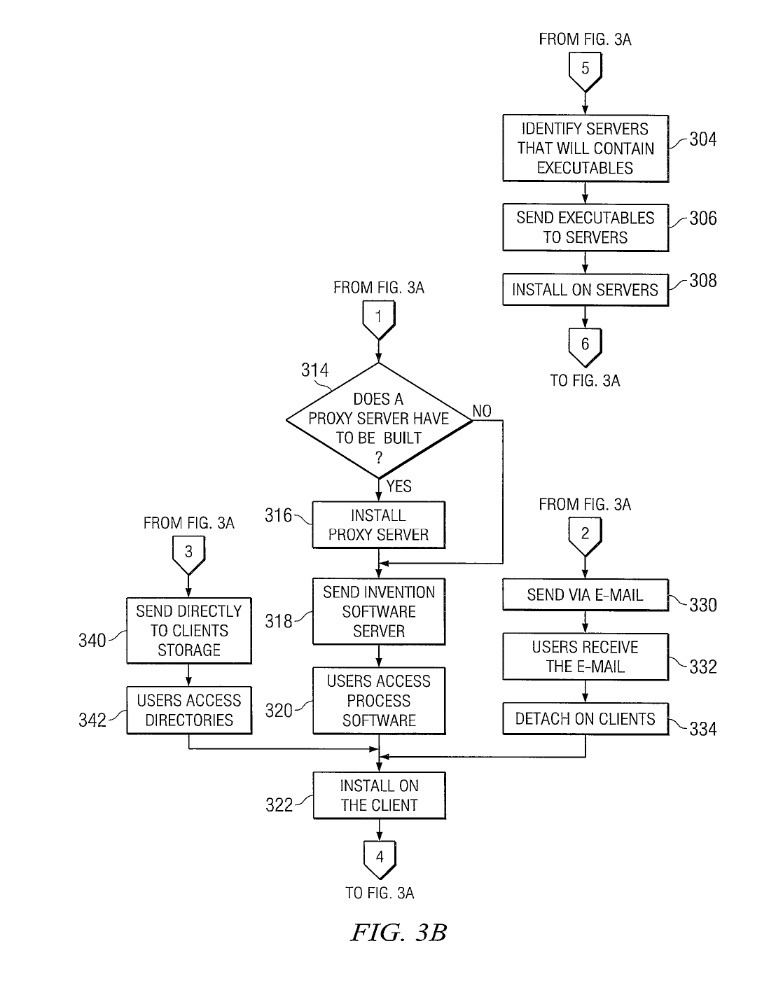

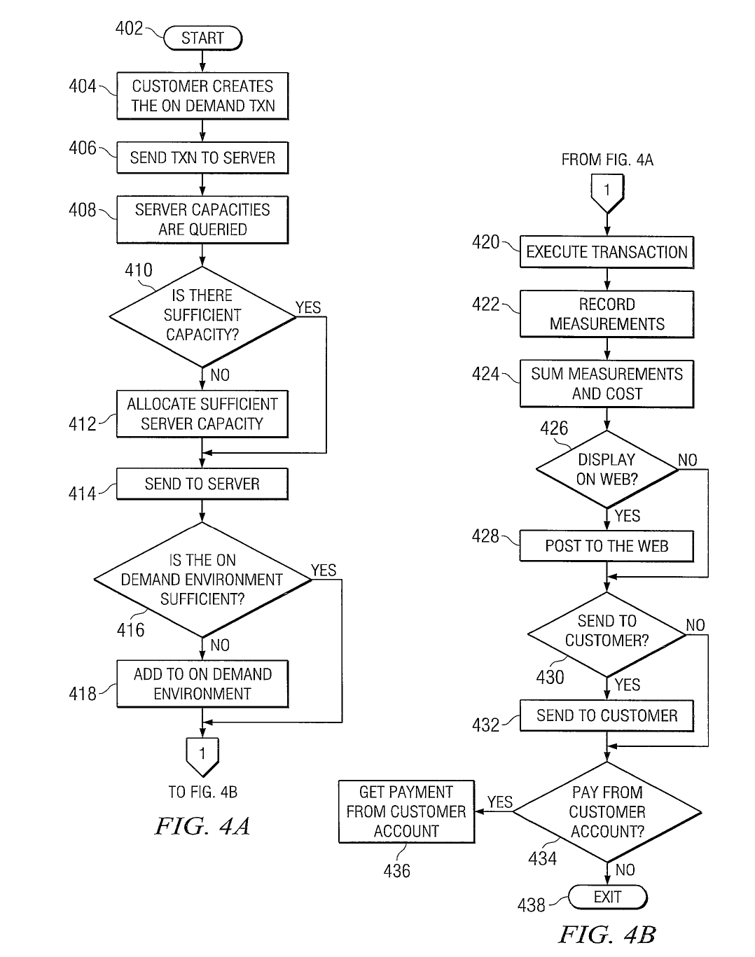

Application programs 144 in computer 102's system memory (as well as software deploying server 150's system memory, gift card issuing server 152's system memory, and/or retail store server 154's system memory) also include an Electronic Gift Card Issuing and Management Logic (EGCIML) 148. EGCIML 148 includes code for implementing the processes described in FIGS. 2-4B. In one embodiment, computer 102 is able to download EGCIML 148 from software deploying server 150, including in an “on demand” basis, as described in greater detail below in FIGS. 3A-4B. Note further that, in a preferred embodiment of the present invention, software deploying server 150 performs all of the functions associated with the present invention (including execution of EGCIML 148), thus freeing computer 102 from having to use its own internal computing resources to execute EGCIML 148.

The hardware elements depicted in computer 102 are not intended to be exhaustive, but rather are representative to highlight essential components required by the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

With reference now to FIG. 2, a high-level overview of steps taken to issue and manage an electronic gift card is presented. After initiator block 202, a gift card issuing server receives an order for a primary electronic gift card (block 204). The order is transmitted from an initial purchaser to a gift card issuer that utilizes the gift card issuing server. The primary electronic gift card has an initial value that, after the order is received and processed by a gift card issuing server, is transmitted, along with a first unique gift card identifier from the gift card issuing server to a first electronic device that is dedicated to the initial purchaser (block 206). If the first electronic device is a computer, then the primary electronic gift card and/or initial value of that card can be sent as an e-mail, instant message, etc. If the first electronic device is a phone, including a cell phone, then the primary electronic gift card and/or initial value can be sent as an e-mail, a voice message, and/or a Short Message Service (SMS) text message.

In response to the purchaser assigning a portion of the primary electronic gift card to an assignee (query block 208), a second unique gift identifier is transmitted (via e-mail, text message, instance message, voice mail, etc.) to a second electronic device (identified in block 210) that is dedicated to the assignee (block 212). This second unique gift identifier identifies a split gift card and a partial value. The split gift card is derived from the primary electronic gift card, and the partial value is sectioned out of and is less than the initial value of the primary electronic gift card.

In response to a retail store receiving, from the assignee of the split gift card, a purchase order for a retail good (query block 214), the gift card issuing server receives the second unique gift card identifier (block 216) from the retail store, and authorizes a payment for the retail good (block 218). The process ends at terminator block 220.

As mentioned above, the initial purchaser and/or the assignee of the split-out gift card may use a computer and/or a telephone (e.g., a cell phone). Thus, the initial purchaser may receive the initial electronic gift card identifier (and amount) as an e-mail (using a computer or a “smart phone”), or as a Short Message Service (SMS) text message on a cell phone. Similarly, the assignee of the split-out gift card may receive the split-out gift card information (and amount) on a computer or phone, via a message from either the initial purchaser or the gift card issuing server. Thus, if the initial purchaser of the initial electronic gift card sends the split-out gift card information to the assignee, then the initial purchaser has total control of the message being sent to the recipient assignee (including responsibility for ensuring that proper security measures are taken to avoid the message being intercepted). Note also that when the electronic gift card is used (either the initial primary electronic gift card or the split gift card), the gift card issuing server will update the value of the electronic gift card, and send that information to the holder (the primary purchaser, the assignee of the split card, and/or the retail store) of the electronic gift card.

It should be understood that at least some aspects of the present invention may alternatively be implemented in a computer-readable medium that contains a program product. Programs defining functions of the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of EGCIML 148, are performed by service provider server 150. Alternatively, EGCIML 148 and the method described herein, and in particular as shown and described in FIG. 2, can be deployed as a process software from service provider server 150 to computer 102. Still more particularly, process software for the method so described may be deployed to service provider server 150 by another service provider server (not shown).

Referring then to FIGS. 3A-B, step 600 begins the deployment of the process software. The first thing is to determine if there are any programs that will reside on a server or servers when the process software is executed (query block 302). If this is the case, then the servers that will contain the executables are identified (block 304). The process software for the server or servers is transferred directly to the servers' storage via File Transfer Protocol (FTP) or some other protocol or by copying though the use of a shared file system (block 306). The process software is then installed on the servers (block 308).

Next, a determination is made on whether the process software is to be deployed by having users access the process software on a server or servers (query block 310). If the users are to access the process software on servers, then the server addresses that will store the process software are identified (block 312).

A determination is made if a proxy server is to be built (query block 314) to store the process software. A proxy server is a server that sits between a client application, such as a Web browser, and a real server. It intercepts all requests to the real server to see if it can fulfill the requests itself If not, it forwards the request to the real server. The two primary benefits of a proxy server are to improve performance and to filter requests. If a proxy server is required, then the proxy server is installed (block 316). The process software is sent to the servers either via a protocol such as FTP or it is copied directly from the source files to the server files via file sharing (block 318). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 320). Another embodiment is to have the servers automatically copy the process software to each client and then run the installation program for the process software at each client computer. The user executes the program that installs the process software on his client computer (block 322) then exits the process (terminator block 324).

In query step 326, a determination is made whether the process software is to be deployed by sending the process software to users via e-mail. The set of users where the process software will be deployed are identified together with the addresses of the user client computers (block 328). The process software is sent via e-mail to each of the users' client computers (block 330). The users then receive the e-mail (block 332) and then detach the process software from the e-mail to a directory on their client computers (block 334). The user executes the program that installs the process software on his client computer (block 322) then exits the process (terminator block 324).

Lastly a determination is made as to whether the process software will be sent directly to user directories on their client computers (query block 336). If so, the user directories are identified (block 338). The process software is transferred directly to the user's client computer directory (block 340). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 342). The user executes the program that installs the process software on his client computer (block 322) and then exits the process (terminator block 324).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a ViPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

### Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers, including the network operating system where the process software will be deployed, that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the accessed server may make requests of other servers that require CPU units. CPU units describe an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and/or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

With reference now to FIGS. 4A-B, initiator block 402 begins the On Demand process. A transaction is created than contains the unique customer identification, the requested service type and any service parameters that further, specify the type of service (block 404). The transaction is then sent to the main server (block 406). In an On Demand environment the main server can initially be the only server, then as capacity is consumed other servers are added to the On Demand environment.

The server central processing unit (CPU) capacities in the On Demand environment are queried (block 408). The CPU requirement of the transaction is estimated, then the server's available CPU capacity in the On Demand environment are compared to the transaction CPU requirement to see if there is sufficient CPU available capacity in any server to process the transaction (query block 410). If there is not sufficient server CPU available capacity, then additional server CPU capacity is allocated to process the transaction (block 412). If there was already sufficient available CPU capacity then the transaction is sent to a selected server (block 414).

Before executing the transaction, a check is made of the remaining On Demand environment to determine if the environment has sufficient available capacity for processing the transaction. This environment capacity consists of such things as but not limited to network bandwidth, processor memory, storage etc. (block 416). If there is not sufficient available capacity, then capacity will be added to the On Demand environment (block 418). Next the required software to process the transaction is accessed, loaded into memory, then the transaction is executed (block 420).

The usage measurements are recorded (block 422). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 424).

If the customer has requested that the On Demand costs be posted to a web site (query block 426), then they are posted (block 428). If the customer has requested that the On Demand costs be sent via e-mail to a customer address (query block 430), then these costs are sent to the customer (block 432). If the customer has requested that the On Demand costs be paid directly from a customer account (query block 434), then payment is received directly from the customer account (block 436). The On Demand process is then exited at terminator block 438.

While the present invention has been particularly shown and described with reference to a preferred embodiment, it will be understood by those skilled in the art that various changes in form and detail may be made therein without departing from the spirit and scope of the invention. For example, while the present description has been directed to a preferred embodiment in which custom software applications are developed, the invention disclosed herein is equally applicable to the development and modification of application software. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method of issuing and managing an electronic gift card, the method comprising:
receiving a gift card purchase order for a primary electronic gift card, wherein the order is transmitted from an initial purchaser to a gift card issuer, wherein the primary electronic gift card has an initial value, and wherein the order is received and processed by a gift card issuing server;
transmitting a first unique gift card identifier from the gift card issuing server to a first electronic device that is dedicated to the initial purchaser, wherein the first unique gift card identifier identifies the primary electronic gift card;
transmitting the initial value of the primary electronic gift card to the first electronic device;
in response to the purchaser assigning a portion of the primary electronic gift card to an assignee, transmitting a second unique gift identifier to a second electronic device that is dedicated to the assignee, wherein the second unique gift identifier identifies a split gift card and a partial value, wherein the split gift card is derived from the primary electronic gift card, and wherein the partial value is sectioned out of and is less than the initial value of the primary electronic gift card; and
in response to a retail store receiving, from the assignee, a purchase order for a retail good, receiving, at the gift card issuing server, the second unique gift card identifier from the retail store as a request to authorize a payment for the retail good.

2. The method of claim 1, wherein the first electronic device is a first cellular phone, and wherein the first unique gift card identifier is transmitted via a first Short Message Service (SMS) text message from the gift card issuing server to the first cellular phone.

3. The method of claim 2, wherein the second electronic device is a second cellular phone, and wherein the second unique gift card identifier is transmitted via a Short Message Service (SMS) text message from the first cellular phone to the second cellular phone.

4. The method of claim 2, wherein the second electronic device is a second cellular phone, and wherein the second unique gift card identifier is transmitted via a Short Message Service (SMS) text message from the gift card issuing server to the second cellular phone.

5. The method of claim 1, wherein the first electronic device is a first computer, and wherein the first unique gift card identifier is transmitted via an e-mail message from the gift card issuing server to the first computer.

6. The method of claim 5, wherein the second electronic device is a second computer, and wherein the second unique gift card identifier is transmitted via an e-mail message from the first computer to the second computer.

7. The method of claim 5, wherein the second electronic device is a second computer, and wherein the second unique gift card identifier is transmitted via an e-mail message from the gift card issuing server to the second computer.

8. The method of claim 1, further comprising:
in response to the retail good being purchased by the assignee using the split gift card, creating an updated value of the split gift card at the gift card issuing server; and
transmitting the updated value of the split gift card to the second electronic device.

9. The method of claim 1, wherein the gift card issuing server authorizes the payment for the retail good.

10. A gift card issuing server configured for issuing and managing an electronic gift card, the gift card issuing server comprising:
logic for receiving an order for a primary electronic gift card, wherein the order is transmitted from an initial purchaser to a gift card issuer, wherein the primary electronic gift card has an initial value, and wherein the order is received and processed by a gift card issuing server;
logic for transmitting a first unique gift card identifier from the gift card issuing server to a first electronic device that is dedicated to the initial purchaser, wherein the first unique gift card identifier identifies the primary electronic gift card;
logic for transmitting the initial value of the primary electronic gift card to the first electronic device;
logic for in response to the purchaser assigning a portion of the primary electronic gift card to an assignee, transmitting a second unique gift identifier to a second electronic device that is dedicated to the assignee, wherein the second unique gift identifier identifies a split gift card and a partial value, wherein the split gift card is derived from the primary electronic gift card, and wherein the partial value is sectioned out of and is less than the initial value of the primary electronic gift card;
logic for, in response to a retail store receiving, from the assignee, a purchase order for a retail good, receiving the second unique gift card identifier from the retail store as a request to authorize a payment for the retail good; and
logic for, in response to receiving the second unique gift card identifier, authorizing the payment for the retail good.

11. A computer-readable medium on which is stored a computer program, the computer program comprising computer executable instructions configured for:
receiving an order for a primary electronic gift card, wherein the order is transmitted from an initial purchaser to a gift card issuer, wherein the primary electronic gift card has an initial value, and wherein the order is received and processed by a gift card issuing server;
transmitting a first unique gift card identifier from the gift card issuing server to a first electronic device that is dedicated to the initial purchaser, wherein the first unique gift card identifier identifies the primary electronic gift card;
transmitting the initial value of the primary electronic gift card to the first electronic device;
in response to the purchaser assigning a portion of the primary electronic gift card to an assignee, transmitting a second unique gift identifier to a second electronic device that is dedicated to the assignee, wherein the second unique gift identifier identifies a split gift card and a partial value, wherein the split gift card is derived from the primary electronic gift card, and wherein the partial value is sectioned out of and is less than the initial value of the primary electronic gift card; and
in response to a retail store receiving, from the assignee, a purchase order for a retail good, receiving, at the gift card issuing server, the second unique gift card identifier from the retail store as a request to authorize a payment for the retail good.

12. The computer-readable medium of claim 11, wherein the first electronic device is a first cellular phone, and wherein the first unique gift card identifier is transmitted via a first Short Message Service (SMS) text message from the gift card issuing server to the first cellular phone.

13. The computer-readable medium of claim 12, wherein the second electronic device is a second cellular phone, and wherein the second unique gift card identifier is transmitted via a Short Message Service (SMS) text message from the first cellular phone to the second cellular phone.

14. The computer-readable medium of claim 12, wherein the second electronic device is a second cellular phone, and wherein the second unique gift card identifier is transmitted via a Short Message Service (SMS) text message from the gift card issuing server to the second cellular phone.

15. The computer-readable medium of claim 11, wherein the first electronic device is a first computer, and wherein the first unique gift card identifier is transmitted via an e-mail message from the gift card issuing server to the first computer.

16. The computer-readable medium of claim 15, wherein the second electronic device is a second computer, and wherein the second unique gift card identifier is transmitted via an e-mail message from the first computer to the second computer.

17. The computer-readable medium of claim 15, wherein the second electronic device is a second computer, and wherein the second unique gift card identifier is transmitted via an e-mail message from the gift card issuing server to the second computer.

18. The computer-readable medium of claim 11, wherein the computer executable instructions are further configured for:
in response to the retail good being purchased by the assignee using the split gift card, creating an updated value of the split gift card at the gift card issuing server; and
transmitting the updated value of the split gift card to the second electronic device.

19. The computer-readable medium of claim 11, wherein the computer-readable medium is a component of a remote server, and wherein the computer executable instructions are deployable to a supervisory computer from the remote server.

20. The computer-readable medium of claim 11, wherein the computer executable instructions are capable of being provided by a service provider to a customer on an on-demand basis.
